(19) United States
(12) Patent Application Publication
(10) Pub. No.: US 2010/0291506 A1
(43) Pub. Date: Nov. 18, 2010

(54) DEVICE FOR DEBRIDEMENT OF IMPLANTS, AND A METHOD FOR DEBRIDEMENT OF IMPLANTS USING THE DEVICE

(76) Inventors: Lennart Olsson, Malmo (SE); Anders Lindberg, Ahus (SE); Olof Bange, Hoganas (SE)

Correspondence Address: FISH & RICHARDSON PC, P.O. BOX 1022, MINNEAPOLIS, MN, 55440-1022, US

(21) Appl. No.: 12/863,630

(22) PCT Filed: Jan. 21, 2009
(86) PCT No.: PCT/EP09/50662

§ 371 Date: Jul. 20, 2010

(30) Foreign Application Priority Data
Jan. 25, 2008 (SE) 0800189-3

(51) Int. Cl. A61C 17/00; A61C 3/02; A61C 17/02

(52) U.S. Cl. 433/143; 433/144; 433/82; 433/216

(57) ABSTRACT

A device (10) for debridement of dental implants, which are arranged into bone tissue and are surrounded by gingiva of a jaw of a human being, has a debriding element (11) and an axle (12) with a fastener (13) for attachment to a rotational apparatus The debriding element (11) has at least one cleaning leg (20) with at least one cutting edge for engagement with the implant, the gingiva and/or the bone tissue According to a second embodiment the debriding element has several portions each having said cleaning leg (20) and the portions are connected to each other Said cleaning leg (20) has a free end (21) shaped as a hook (30) with a point (31), which is provided with said cutting edge The device (10) may have several cleaning legs (20), each provided with several cutting edges A method for cleaning and abrasion of dental implants and implant sites are provided, which uses the device (10) for abrasion and cleaning.

### TECHNICAL FIELD

The present invention relates to a device for debridement of dental implants and of the implant sites when the implants are arranged into the bone tissue of the jaw of a human being. Furthermore, the invention relates to a method for debridement of implants and of the implant sites using the device, when the implants are anchored into the jaw of a human being.

### BACKGROUND ART

Implants for anchoring single or several artificial teeth forming dental bridges or implant bridges exist since a couple of decades. Currently, there are more than two thousands implants available on the market.

The implants have to be accepted by the bone tissue of the jaw of the human being after arrangement into the oral cavity, before temporarily or permanently fastening artificial teeth or dental bridges on the implants, such that the implants are healed up into the bone tissue. When the implants have been arranged into the bone tissue, either the edges of the mucous membrane are stitched together, or healing abutments are temporarily arranged to each of the implants in such way that a portion of each healing abutment protrudes above the gingiva. The healing abutments prevent soft tissue and bone tissue to grow into areas of the implants that should be free from tissue, and shape the gingiva during healing up the implants. The implants are usually left unloaded for a couple of months to ensure that they are fully healed up into the bone tissue, which is a prerequisite for the future arrangement of the dental bridge. In cases wherein the edges of the mucous membrane are stitched together during implant healing up, a second surgery is required to uncover the implants when it is time for making an impression for the manufacturing of a model. Thereafter, healing abutments should temporarily cover the implants to protect those from tissue growth until the gingiva is healed up. The dental bridge, which is manufactured from a model of the jaw with the implants arranged therein, will then be fastened to the implants by screws through bridge supports of the bridge construction, and the gingiva will rapidly adapt to the implants.

For prolonging the lifetime and the functionality of the implants it can be necessary to clean the implants after a time period of use, which is performed when the implants are fastened in site into the jaw. During the cleaning procedure micro organisms are removed, such as bacteria or bacteria toxins that may cause infections.

An implant correctly arranged into the bone tissue of a human being will stay intact as long as the implant is not affected by external effects, such as exposure of mechanical stresses, bacteria or bacteria toxins, which in different ways will affect the gingiva and implant site. For example, if surfaces of the implant are exposed, which at correct conditions are anchored into the bone tissue and covered by the gingiva, bacteria and bacteria toxins easily will fasten to these parts of the implant that also may include external threading, which may result in an infection of the gingiva and further to bone break down of the bone tissue. When the gingiva, for any reason, creeps back from the implant showing a part of the implant that normally should be covered, or if pockets or recesses are formed closed to the implant, the implant site will be susceptible for growth of bacteria or bacteria toxins, which may lead to infections and further to bone break down. In the latter case, the bone of the jaw, keeping the implant in site, is attacked by the bacteria or bacteria toxins and starts to break down. At a certain stage the bone break down will accelerate, which has been shown by means of x-rays. Implant surfaces that have become uncovered, previously surrounded by bone tissue and healed up therein, are now susceptible for bacteria colonies providing infections and leading to accelerated bone break down. At this stage, it is necessary to initiate treatment; otherwise the implant will become loose and then fall off. The uncovered implant surface must be cleaned from bacteria and bacteria toxins, to retard or cease the bone break down. Currently, cleaning processes of dental implants are performed by means of traditionally drills and abrasive or grinding tools commonly used by the dentists. The process of grinding and polishing the implant surfaces above the level of the bone tissue is time consuming; up to two hours are required for each implant to be cleaned, despite this long time period, a satisfactory result is difficult to reach. Another drawback is that today's cleaning processes involve use of chemicals, e.g. acids to dissolve lime deposits that negatively affects the blood circulation (acids coagulate blood), and hydrogen peroxides for removing protein layers by oxidation. Often, the cleaning process has to be repeated after another five years due to a new infection.

### SUMMARY OF THE INVENTION

An object of the present invention is to eliminate at least one of the drawbacks mentioned above, which is achieved by assigning to a device for debridement of dental implants, arranged into bone tissue and surrounded by gingiva of a jaw of a human being, the characteristics according to claim 1. A further object of the invention is to provide a method for debridement of implants arranged into bone tissue and surrounded by gingiva of a jaw of a human being by use of the device for debridement.

According to a first aspect of the invention, there is provided a device of a first embodiment for debridement of dental implants, which has a debriding element and an axle with a fastener for attachment to a rotational apparatus. The debriding element has at least one cleaning leg with at least one cutting edge for engagement with the implant, the gingiva and/or the bone tissue for cleaning and abrasion thereof. According to a second embodiment, the debriding element of the device has several portions each having at least one cleaning leg with at least one cutting edge, the portions being connected to each other by connection members.

Said cleaning leg has a free end and is shaped as at least one hook with at least one point, which is provided with the at least one cutting edge for engagement with the implant, the gingiva or the bone tissue. Preferably, said hook has several cutting edges and said cleaning leg has at least one longitudinal cutting edge for engagement with the gingiva. Preferably the device has several cleaning legs that may be symmetrically or not symmetrically arranged around a plate of the debriding element, so that the hooks are arranged either at equal or not equal distances from each other. The hooks are in contact with the implant during the debridement. Said cleaning legs have lengths that differ from each other so that the points of the hooks of said cleaning legs are forming a screw line corresponding to a screw line of an external threading of implants. The axle has a through channel for supplying a fluid during the debridement for disposal of removed implant material, tissue, bacteria, blood or impurities. In another embodiment, the through channel opens into a through hole of the plate.

According to a second aspect of the invention, there is provided a method for debridement of a dental implant with a device described above, wherein the implant is fastened into bone tissue and is surrounded by gingiva of a jaw of a human being. According to the method, the gingiva around the implant firstly has to be cut up for uncovering a larger part of the implant. Then, said device is fastened to a rotating apparatus, and is arranged at the implant in such way that said cutting edges of said cleaning legs are engaged with the implant, the gingiva and/or the bone tissue. The rotating apparatus is started for moving the device by rotation while said cutting edges of said cleaning legs are in engagement with the implant, the gingiva and/or the bone tissue for abrasion and cleaning. The device is moved by rotation clockwise and anticlockwise along and around the implant until the abrasion and cleaning is completed. A fluid is supplied during the rotation of the device for disposal of removed tissue or implant material, blood, bacteria and/or other impurities. Finally, the flaps of the gingiva are closed by stitching. An additional step may use a mounting cone, arranged upon the implant, having an external threading corresponding to a screw line of the cleaning legs of the device for facilitating the engagement of the device with the implant.

Further objects, features and advantages of the present invention will appear from the following detailed description, from the attached drawings as well as from the dependent claims.

### BRIEF DESCRIPTION OF THE DRAWINGS

In order to explain the invention, a number of embodiments of the invention will be described below with reference to the drawings, in which:

FIG. 1 shows a perspective view of a schematic device for debridement of dental implants and dental sites according to a first embodiment,

FIG. 2 shows an exploded view of the device in FIG. 1,

FIG. 3 shows a side view of the device in FIG. 1,

FIG. 4 shows a cross view of the device in FIG. 3,

FIG. 5 shows a perspective view of a device for debridement of dental implants according to a third embodiment,

FIG. 6 shows an exploded view of the device in FIG. 5,

FIG. 7 shows a side view of a mounting cone arranged on an implant that is fastened into bone tissue and surrounded by gingiva of a jaw of a human being, and

FIG. 8 shows the device in engagement with the implant during debridement. Same reference numerals have been used to indicate the same parts in the figures to increase the readability of the description and for the sake of clarity. The figures are not made to scale, and the relative dimensions of the illustrated objects may be disproportional.

### DETAILED DESCRIPTION

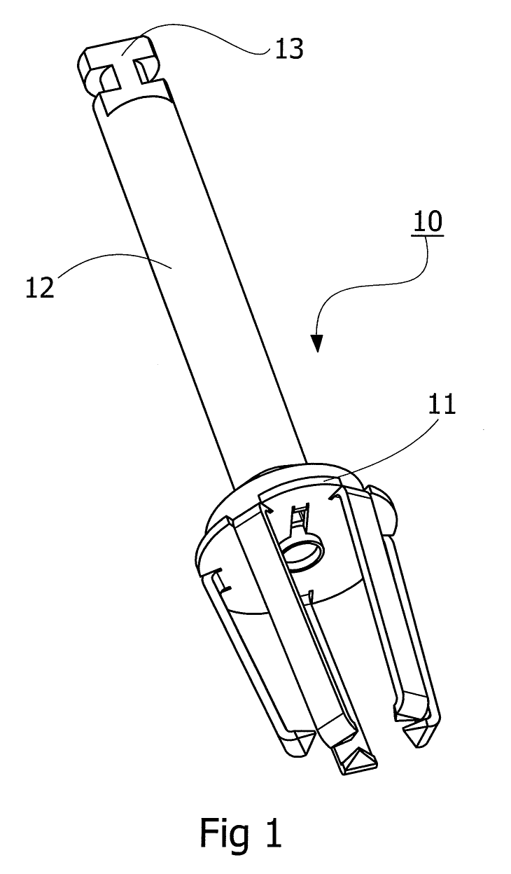

In the description below the expression “debridement of implant” should be understood as a process for cleaning the implant from deposit of different types, such as bacteria and bacteria toxins, lime deposits, layers of protein or other impurities, which process also may include abrasion of a thin layer of the implant material for polishing the implant surface to become smooth and more inert for attachment of deposits from the surrounding oral cavity. FIG. 1 shows a device 10 for debridement of dental implants and corresponding implant site for use when the implants are arranged in place into the bone tissue of the jaw of a human being. The implant site is defined as the bone tissue of the jaw, wherein said implant is fastened, and the surrounding soft tissue, such as the gingiva. The device has a debriding element 11 and an axle 12 having a fastener 13, which for example is a RA (Right Angle) fastener according to known standard for engagement with a dentist drill, another rotating apparatus or a handle (not shown) for rotating the device 10 at the debridement. The debriding element 11 and the axle 12 are firmly connected to each other, forming a cooperating unit.

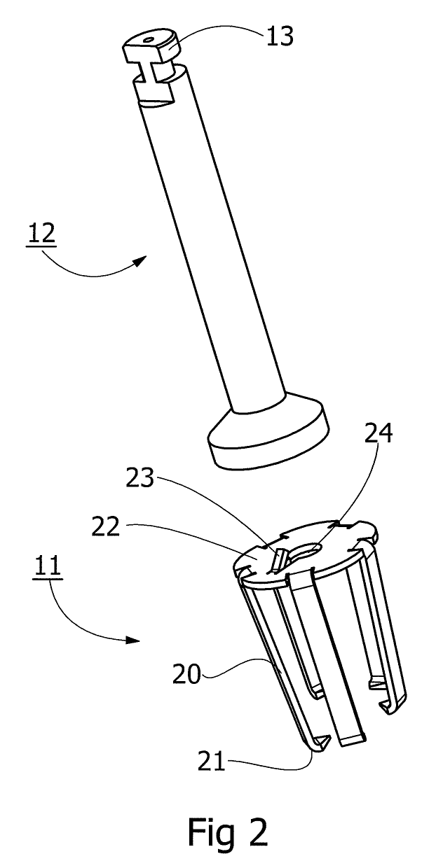

As shown in FIG. 2, the debriding element 11 has five cleaning legs 20, each with a first free end 21 and a second end connected to a plate 22, which is substantially perpendicular to the axle 12. The cleaning legs 20 are arranged in angle with the plate 22 in direction towards the implant at the debridement. The cleaning legs 20 and the plate 22 are integrally made and are made of the same material, such as a polymeric or a metallic material. The plate 22 has a fastening element 23 for connection to the axle 12 and is provided with a through hole 24.

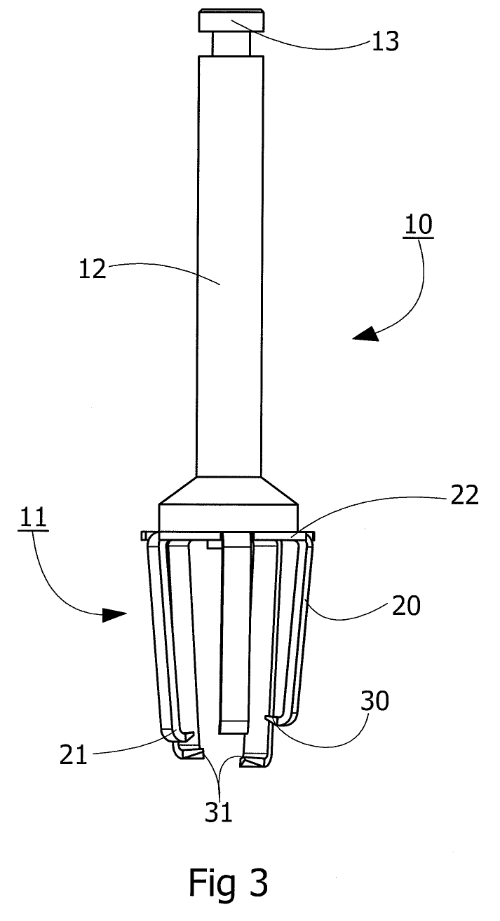

FIG. 3 is a side view of the device 10; showing that the free end 21 of each cleaning leg 20 is shaped as at least one hook 30 and ends in at least one point 31. The cleaning legs 20 are angled in relation to the plate 22 and are symmetrically arranged around the plate 22, so that the hooks 30 are arranged at equal distances from each other. The hooks 30 are in contact with the implant during the debridement.

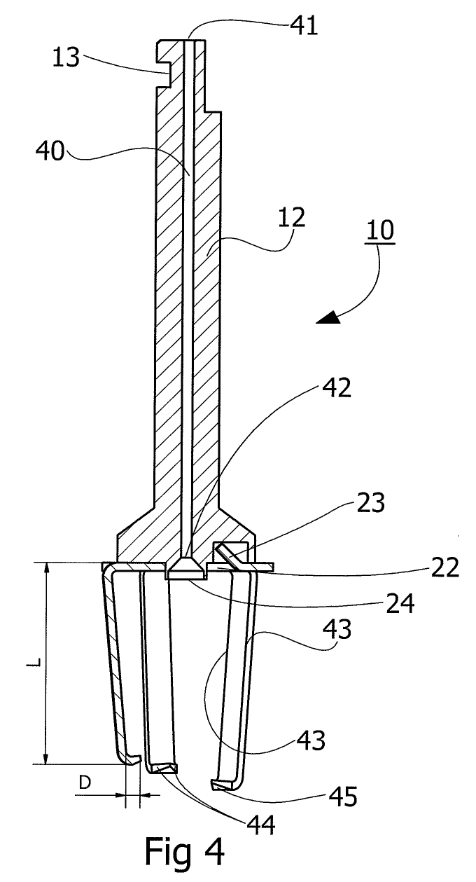

FIG. 4 shows the device 10 in cross section. The axle 12 has a through channel 40, which is adapted to be connected to a fluid supply at a first end 41 at the fastener 13 and which is opening into the plate through hole 24 of the debriding element 11. Each cleaning leg 20 has at least one longitudinal first edge 43, angled second edges 44 forming the point 31 and a bottom third edge 45, which are in engagement with the implant, the gingiva and/or the bone tissue during the debridement. The measure D of each hook is essential at the debridement when the implant is provided with an external threading; D must be larger than the full deep of the threading to reach the bottom of the threading for abrasion and cleaning thereof. The cleaning legs 20 of the device 10 have lengths L that differ in relation to each other. The points 31 are forming a screw line due to said differences in length L, and this screw line may correspond to a screw line of a threading of an implant. The points 31 are directed towards the implant and are engaged with the implant at the debridement.

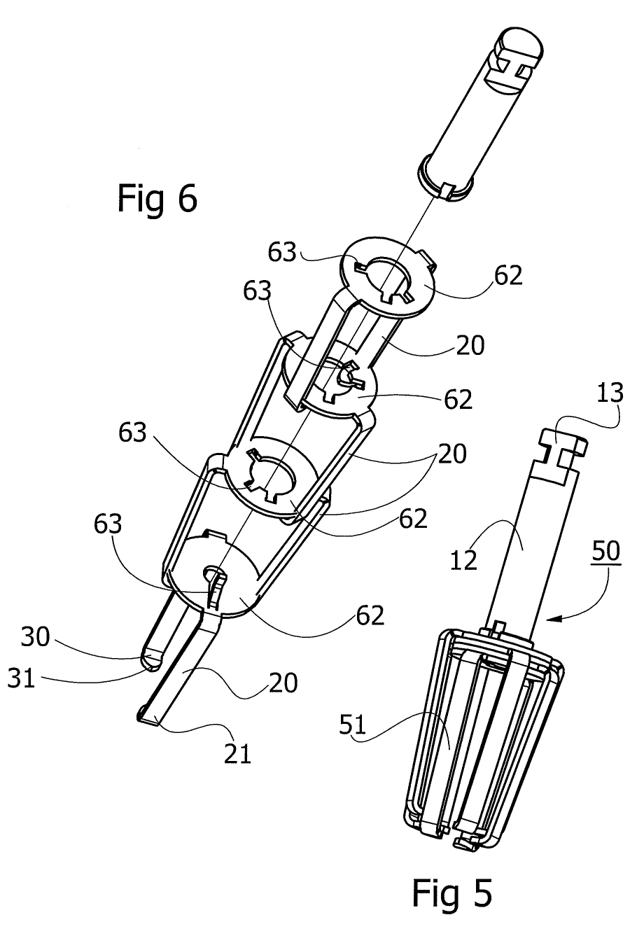

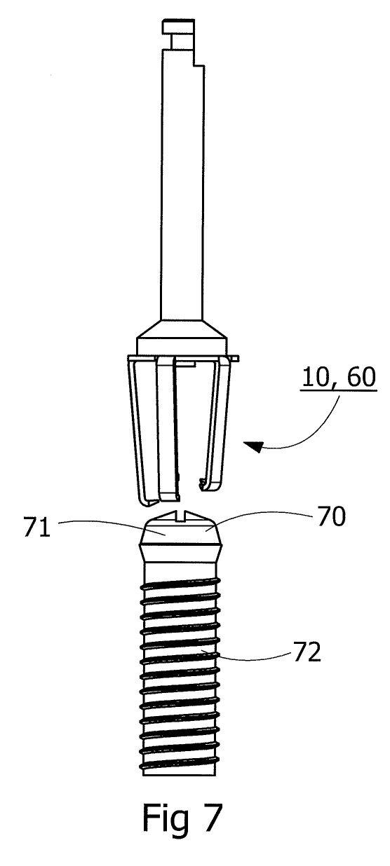

In alternate embodiments of the device 10, the debriding element 11 may be provided with any numbers of cleaning legs 20, such as one, two, three, or four, or preferably five, six or seven, but more legs could be provided. The device 10 has small dimensions in reality; a limited space is available for the arrangement of the cleaning legs 20. Furthermore, the cleaning legs 20 must have a relative rigidity required for the debriding function; due to the available space, many legs will involve thinner legs and thus lower rigidity is obtained for each leg, which may jeopardize the debriding function. In summary, the numbers of cleaning legs 20 should be chosen with regard to the rigidity of the material quality used for obtaining the desired debriding effect. FIG. 5 shows a second embodiment of the device 50, having an axle 12, as described above, and a debriding element 51, which is formed by several portions, as shown by the exploded view in FIG. 6. Each portion has two cleaning legs 20 with a free end 21 shaped as a hook 30 ending in a point 31, as described above, and connected to a plate 62 at an end opposite the free end 21. Each cleaning leg 20 is provided with at least one longitudinal first edge 43, angled second edges 44 and a bottom third edge 45, and the device 50 has the same features as described in connection with the first embodiment 10. The several portions are firmly connected to each other by a connection member 63. The number of portions may be any number, such as 2, 3, 4, 5, or more, and the number of legs 20 of each portion may vary. FIG. 7 shows a side view of a cap or mounting cone 70 arranged at the implant for facilitating the arrangement of the device 10, 50, 60 thereto before starting the debridement. The cone 70 has an external threading 71 that corresponds to the screw line formed by the points 30 of the cleaning legs 20. An implant may also be provided with an external threading that may or may not correspond with the threading 71 of the cone 70. The cone can be truncated, or can have a rounded top.

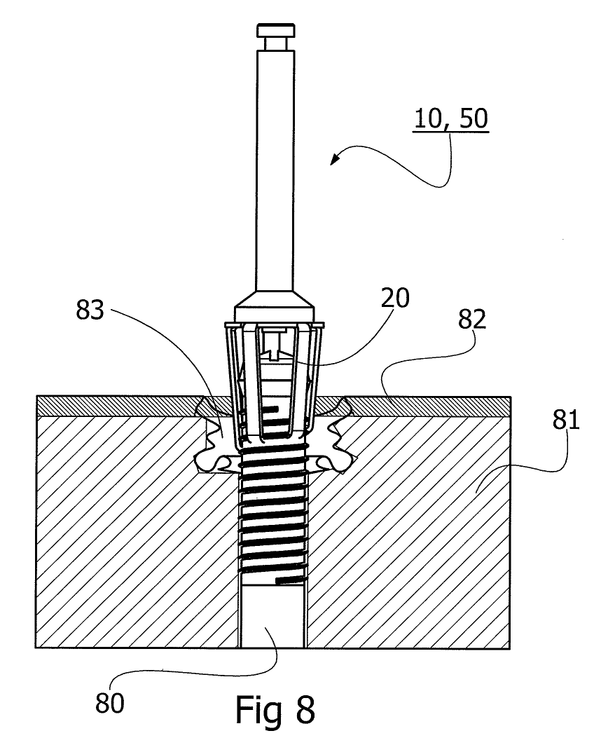

FIG. 8 illustrates an implant 80 arranged into the bone tissue 81 of a jaw and surrounded by the gingiva 82. A cavity 83 has been formed around the implant due to external stresses, wherein bacteria have entered causing an infection, which will lead to possible bone break down. The device for debridement 10, 50 is arranged at the implant in such way that the cleaning legs 20 of the debriding element 11 are engaged with the implant 80. The method for debridement of a dental implant and the implant site with the device 10, 50 as disclosed above, will now be described. The implant is arranged in site into the bone tissue 81 and is surrounded by the gingiva 82 of the jaw. Firstly the gingiva has to be cut up around the implant 80 for uncovering a larger part of the implant; the flaps of the gingiva will be turned apart. The device 10, 50 is then fastened by the fastener 13 of the axle 12 into a rotating apparatus, such as a drill or other rotational apparatus, or a handle for manually rotation. Preferably the device 10, 50 has several cleaning legs 20 provided with several cutting edges 43, 44, 45. The device 10, 50 is then arranged at the implant in such way that said cutting edges 44, 45 of the hooks 30 of the cleaning legs 20 are engaged with the implant. The rotating apparatus is started for moving the device 10, 50 by rotation, while said cutting edges 44, 45 of said cleaning legs are in engagement with the implant. Then, the device 10, 50 is moved by rotation clockwise and anticlockwise along and around the implant, while the cutting edges 44, 45 are in engagement with the implant for abrasion and cleaning, and also with the bone tissue at the moment for changing directions of the movement. The longitudinal cutting edges 43 are in engagement with the gingiva for removing infected tissue. During the process, simultaneously the implant 80 is cleaned from bacteria and bacteria toxins, lime deposits, layers of protein or other impurities, but also the process provides abrasion of a thin layer of the implant material for polishing the implant surface to become smooth and more inert for attachment of deposits from the surrounding oral cavity. Infected gingiva is removed by abrasion by the longitudinal cutting edges 43, and optimally infected bone tissue will be removed by the cutting edges 44, 45. A fluid, such as water or salt solution, is supplied during the rotation of the device 10, 50 by the through channel 40 of the axle 12, and further through the hole 24 of the plate 22 of the debriding element 11, for disposal of removed tissue or implant material, blood, bacteria and/or other impurities. When the cleaning and abrasion is completed, the flaps of the gingiva are closed by stitching.

An additional step of the method uses the mounting cone 70, see FIG. 7, having an external threading 71 corresponding to the screw line of the points 31 of the cleaning legs 20. Also, when the implant has an external threading, the threading 71 of the cone 70 may correspond to this one, but it is not necessary. The cutting edges 44, 45 of the cleaning legs will act on all uncovered surfaces of the implant that have to be cleaned, irrespective if an external threading is provided on the implant.

The device and method for debridement of implants and implant sites offer a fast way to for cleaning and abrasion, with a reliable and satisfactory result. In the claims, the term “comprises/comprising” does not exclude the presence of other elements or steps. Furthermore, although individually listed, a plurality of means, elements or method steps may be implemented. Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way.

For example, cleaning legs 20 not symmetrically arranged around the plate 22 provide that the points 31 of the hooks 30 are not arranged at equal distances from each other.

1. A device for debridement of dental implants, which are arranged into bone tissue and are surrounded by gingiva of a jaw of a human being, has a debriding element and an axle with a fastener for attachment to a rotational apparatus, the debriding element having at least one cleaning leg with at least one cutting edge for engagement with the implant, the gingiva and/or the bone tissue.

2. The device according to claim 1, wherein the debriding element has several portions each having at least one said cleaning leg, and wherein the portions are connected to each other by connection members.

3. The device according to claim 1, wherein said at least one cleaning leg has a free end shaped as at least one hook with at least one point, which is provided with the at least one cutting edge for engagement with the implant or the bone tissue.

4. The device according to the claim 3, wherein said hook has several cutting edges.

5. The device according to claim 1, wherein said at least one cleaning leg has at least one longitudinal cutting edge for engagement with the gingiva.

6. The device according to claim 1, wherein the debriding element has a plate arranged substantially perpendicular to the axle and said at least one cleaning leg is arranged in angle with the plate in the direction towards the implant.

7. The device according to claim 1, wherein said device has several cleaning legs.

8. The device according to claim 7, wherein said cleaning legs are arranged symmetrically around the plate, so that the hooks are arranged at equal distances from each other and are in contact with the implant during the debridement.

9. The device according to claim 7, wherein said cleaning legs are not arranged symmetrically around the plate, so that the hooks are not arranged at equal distances from each other but are in contact with the implant during the debridement.

10. The device according to claim 7, wherein said cleaning legs have lengths that differ from each other such that the points of said cleaning legs form a screw line corresponding to a screw line of an external threading of each implant.

11. The device according to claim 1, further comprising a cap having an external threading corresponding to the threading of the implant, is provided and arranged upon the implant for facilitating the arrangement of the device on the implant.

12. The device according to claim 1, wherein the axle has a through channel opening into a through hole of the plate for supplying a fluid during the debridement.

13. A method for debridement of a dental implant with a device according to claim 1, the implant being fastened into bone tissue and surrounded by gingiva of a jaw of a human being, the method comprising the following steps:
cutting up the gingiva around the implant for uncovering a larger part of the implant,
fastening said device to a rotating apparatus,
arranging the device upon the implant in such way that said cutting edge of the cleaning leg is engaged with the implant, the gingiva and/or the bone tissue,
starting the rotating apparatus for moving the device by rotation while said cutting edge of said at least one cleaning leg is in engagement with the implant, the gingiva and/or the bone tissue for abrasion and cleaning, and -closing the gingiva by stitching.

14. The method according to claim 13, wherein said at least one cleaning leg of said device is provided with several cutting edges for engagement with the implant, the gingiva and/or the bone tissue for cleaning and/or abrasion during rotation of the device.

15. The method according to claim 13, wherein said at least one cleaning leg of said device is provided with at least one longitudinal cutting edge for abrasion of infected portions of the gingiva surrounding the implant during the rotation of the device.

16. The method according to claim 13, wherein said device is provided with several cleaning legs for engagement with the implant, the gingiva and/or the bone tissue for cleaning and/or abrasion during rotation of the device.

17. The method according to claim 13, wherein the device is moved by rotation clockwise and anticlockwise along and around the implant until cleaning is completed.

18. The method according to claim 16, wherein said cleaning legs have lengths that differ from each other such that the points of said cleaning legs are forming a screw line corresponding to a screw line of an external threading of each implant.

19. The method according to claim 13, wherein a cap, having an external threading corresponding to the threading of the implant, is provided and arranged upon the implant for facilitating the arrangement of the device on the implant.

20. The method according to claim 13, wherein a fluid is supplied during the rotation of the device for disposal of removed tissue or implant material, blood, bacteria and/or other impurities.
